(19) United States
(12) Patent Application Publication
(10) Pub. No.: US 2009/0043680 A1
(43) Pub. Date: Feb. 12, 2009

(54) SYSTEM AND METHOD FOR COORDINATING STUDENT LOANS

(76) Inventor: Keith ALLIOTTS, Tenafly, NJ (US)

Correspondence Address: BLANK ROME LLP, 600 NEW HAMPSHIRE AVENUE, N.W., WASHINGTON, DC, 20037, US

(21) Appl. No.: 11/957,045

(22) Filed: Dec. 14, 2007

Related U.S. Application Data
(63) Continuation-in-part of application No. 11/889,128, filed on Aug. 9, 2007.

(51) Int. Cl. G06Q 40/00

(52) U.S. Cl. 705/35

(57) ABSTRACT

A system and method that allows coordination of loans by providing a website where borrowers may enter information about themselves and receive a listing of multiple lending institutions interested in entering into loan agreements with those borrowers. Other applications of the system and method include, but are not limited to, tracking referrals of borrowers to lending institutions made based on selection criteria submitted by the lending institutions and personal information submitted by the borrower for purposes of collecting a referral fee from the lending institution paid to referring agents.

### CROSS-REFERENCE TO RELATED APPLICATIONS

The present application is a continuation-in-part of co-pending application Ser. No. 11/889,128, the contents of which are incorporated herein in their entirety.

### BACKGROUND OF THE INVENTION

1. Field of Invention

The present invention relates generally to the field of electronic commerce using a networked communications system. More particularly, the invention relates to systems and methods for coordinating student loan borrowers and lending institutions via an on-line web site.

2. Description of Related Art

Lending institutions rely on different techniques for generating new clients, including promotion and advertising techniques, affiliation programs, and referrals. Referrals are clients that have learned about the lending institutions through word-of-mouth endorsements, third party loan originators, and other persons. Traditionally, third party loan originators would receive a referral fee from the lending institutions for every bare, partial-qualified, or qualified lead, depending on the terms of the referral program. With the Internet touching nearly every channel of goods and services in commerce today, it makes sense to use the Internet to increase the number of referrals that lending institutions receive by providing a convenient web-site where borrowers may search for and contact several lending institutions at a single user session.

Student loans are no exception. Traditional methods of applying for student loans involved a borrower contacting individual lending institutions via a communications network, such as via a telephony or Internet system, to learn whether any of the contacted lending institutions would be interested in entering into a loan agreement with the borrower. Each contact would involve providing personal information to the lending institutions, such as the borrower's name, contact information, the state where the borrower's school is located, the amount to be borrowed, any credit history or co-borrower information, and other information requested by the lending institution. Then, if the lending institution were interested in working with the borrower, based on its review of the information provided by the borrower and other information about the borrower available from third parties, the lending institution would provide to the borrower its terms and conditions associated with the lending institution's loan programs. The borrower would then review those terms and conditions, and any terms and conditions provided by other lending institutions, before making a decision regarding whether to enter into a loan agreement.

To simplify that process, systems and methods for collecting borrower data and transmitting that data to lending institutions after filtering the data based on selection criteria provided by the lending institution have been developed. The inventions disclosed in U.S. Pat. Nos. 6,385,594 and 6,611,816, for example, relate to coordinating an electronic credit qualification form between an Internet user and multiple lending institutions via the Internet. The disclosed inventions include a method and computer system for displaying forms on a web site and receiving credit data from users via those forms. After receiving the data, a loan processing computer applies a filter to the data comprising loan selection criteria provided by lending institutions. That filter eliminates loan applications that the lending institutions do not want. Next, after the received data are filtered, the data are transmitted to the lending institutions. Finally, the computer and the method controls and coordinates communication between the lending institutions and the user to match borrowers and lenders via the Internet.

In a broader context, the invention disclosed in U.S. Patent Appl. Pub. No. 2004-0205019 relates to a loan processing computer that automatically applies a first filter to the user's data, and then uses a second filter that may be applied to qualification form data that remains after the first filter, in order to identify potential borrowers. That second filter may be customized by a financial service provider who may also control the process of applying the second filter in a semi-manual manner.

Systems and methods for coordinating financial services between consumers and financial service providers and wholesale investors have also been developed in recent years. The invention disclosed in U.S. Patent Appl. Pub. No. 2006-0100944, which is entitled “Method and computer network for co-ordinating financial services/products,” relates to coordinating an electronic qualification form between consumers and financial service providers and wholesale investors.

Computer systems that allow borrowers to access mortgage information over the Internet have also been developed. For example, the invention disclosed in U.S. Patent Appl. Pub. No. 2004-0199458 relates to a system that allows consumers to access mortgage information and mortgage financing through a computer network.

The invention disclosed in U.S. Pat. No. 5,995,947 relates to trading loans in real time by making loan applications, such as home mortgage loan applications, and placing them up for bid by a plurality of potential lenders.

What the aforementioned prior art systems and methods fail to address, however, among other things, is the data security and liability concerns raised by receiving and transmitting personal background information and credit data collected about borrowers to lending institutions. Also, the aforementioned systems and methods may be overly complicated, in view of the fact that many lending institutions simply want potential customer leads that they can turn into actual revenue-generating customers. Systems and methods that focus on simplifying the process of sending qualified customer leads to lending institutions, and that account for the data security and liability concerns associated with using electronic communications for transmitting highly personal information, would be desirable.

### SUMMARY AND OBJECTS OF THE INVENTION

In view of the lack of suitable solutions to the aforementioned problems offered in the prior art, and given today's market and consumer demands regarding privacy of personal information, it should be apparent that there exists a need for a system and method for coordinating student loans over a communications network, like the Internet, that does not involve collecting highly personal background information or credit data about borrowers, in order to give borrowers a positive experience about seeking out a coordination system to help them obtain acceptable loans.

It should also be apparent that there exists a need for a system and method for coordinating student loans over a communications network, like the Internet, that does not involve transmitting to lending institutions highly personal background and credit data information collected about a borrower that may not be needed by the lending institutions to make an initial informed decision about lending money to the borrower.

It should also be apparent that there also exists a need for a system and method that may track successful referrals of borrowers to lending institution without transmitting to the lending institutions highly personal information and credit data collected about the borrower. To facilitate and simplify such a system, the coordinator should be barely visible in the process.

Accordingly, a principal object of the present invention is to provide systems and methods for coordinating student loans, by providing a web site where borrowers may enter certain general and personal information and receive a listing of lending institutions interested in entering into loan agreements with those borrowers.

It is another object of the invention to provide a system and method for coordinating student loans, by identifying potential borrowers and referring them to lending institutions which then may enter into loan agreements with those borrowers.

It is still another object of the invention to provide a system and method for coordinating student loans, by minimizing the interaction of the coordination system so that borrowers and lending institutions are put in contact with each other in an expedited manner.

It is another object of the present invention to provide a system and method for referring borrowers interested in borrowing money that have been prescreened to meet certain lending institution criteria to lenders without directly transmitting any unnecessary highly personal information or credit data about the borrower.

It is still another object of the present invention to provide a system and method for maintaining a database of lending institution selection criteria allowing the selection criteria to be matched against each borrower that submits personal information to the system.

It is another object of the present invention to provide a system and method for tracking referrals of borrowers to lending institutions made by the system for purposes of collecting a referral fee from the lending institutions.

It is still another object of the present invention to provide a system and method for automatically generating an invoice detailing referrals made to facilitate referral fee collection.

Briefly described, those and other objects and features of the present invention are accomplished, as embodied and fully described herein, by a system for coordinating student loans that includes a server in data communication with one or more lending institution client computers, for entering and sending a plurality of selection criteria to the server, and one or more borrower client computers associated with borrowers interested in borrowing money, for entering and sending a set of information about the borrowers to the server; a data processing subsystem for comparing the set of personal information to the plurality of selection criteria and returning a list of one or more matching lending institutions to the borrower and the lending institution client computers, wherein the list comprises at least one link; and a signal receiving subsystem for receiving a signal from the lending institution client computers indicating an activation of the at least one link.

The objects and features of the present invention are also accomplished, as embodied and fully described herein, by a method for referring money borrowers to lending institutions, which includes at a first server, the steps of receiving over a first communications network a set of selection criteria from each of a plurality of lending institutions; receiving over a second communications network a set of information from a first user, the set of information comprising information about a borrower; comparing the set of selection criteria from each of the plurality of lending institutions to the set of information; identifying one or more of the plurality of lending institutions whose set of selection criteria is satisfied by the set of information; outputting to the user a first signal comprising information about the identified lending institutions; outputting to at least one of the identified lending institutions a second signal comprising instructions to access the first server and receive at least some of the information about the borrower; and receiving a third signal from the at least one of the identified lending institutions about the status of a loan.

With those and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a schematic drawing of the general system architecture of a loan coordinating system according to one aspect of the present invention;

FIG. 1A is a schematic drawing of the system architecture of a loan coordinating system according to one aspect of the present invention;

FIG. 2 is a schematic drawing of the client-server architecture of a loan coordinating system according to one aspect of the present invention;

FIG. 3 is a schematic drawing of the server-side architecture of a loan coordinating system according to one aspect of the present invention;

FIG. 4 is another schematic drawing of the server-side architecture of a loan coordinating system with communications to various third party information providers according to one aspect of the present invention;

FIG. 5 is another schematic drawing of the server-side architecture of a loan coordinating system with a database external to the server(s) according to one aspect of the present invention;

FIG. 6 is another schematic drawing of the server-side architecture of a loan coordinating system with a database internal to the server(s) according to one aspect of the present invention;

FIG. 7 is another schematic drawing of the server-side architecture of a loan coordinating system with a database for storing lender selection criteria and borrower personal information according to one aspect of the present invention;

FIG. 8 is a schematic drawing of a system for coordinating loans through a loan aggregator according to one aspect of the present invention;

FIG. 9 is a schematic drawing of the lending institution client-side architecture of a loan coordinating system according to one aspect of the present invention;

FIG. 10 is another schematic drawing of the lending institution client-side architecture of a loan coordinating system with a plurality of lending institutions according to one aspect of the present invention;

FIG. 11 is another schematic drawing of the lending institution client-side architecture of a loan coordinating system with a plurality of lending institutions and a lending institution aggregator according to one aspect of the present invention;

FIG. 12 is a schematic drawing of the borrower client-side architecture of a loan coordinating system according to one aspect of the present invention;

FIG. 13 is another schematic drawing of the borrower client-side architecture of a loan coordinating system with a plurality of borrowers according to one aspect of the present invention;

FIG. 14 is another schematic drawing of the borrower client-side architecture of a loan coordinating system with a plurality of borrowers and a borrowing aggregator according to one aspect of the present invention;

FIG. 15 is another schematic drawing of the borrower client-side architecture of a loan coordinating system with communications to various third party information providers according to one aspect of the present invention;

FIG. 15A is a drawing representing an HTML link containing borrower personal information according to one aspect of the present invention;

FIG. 16 is a process flow diagram depicting the server-side process flow according to an embodiment of the present invention;

FIG. 16A is a process flow diagram depicting the server-side and client-side process flow according to an embodiment of the present invention;

FIG. 17 is a process flow diagram depicting the borrower client-side process flow according to an embodiment of the present invention; and

FIG. 18 is a process flow diagram depicting the server-side referral tracking process flow according to an embodiment of the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawings.

I. System Architecture.

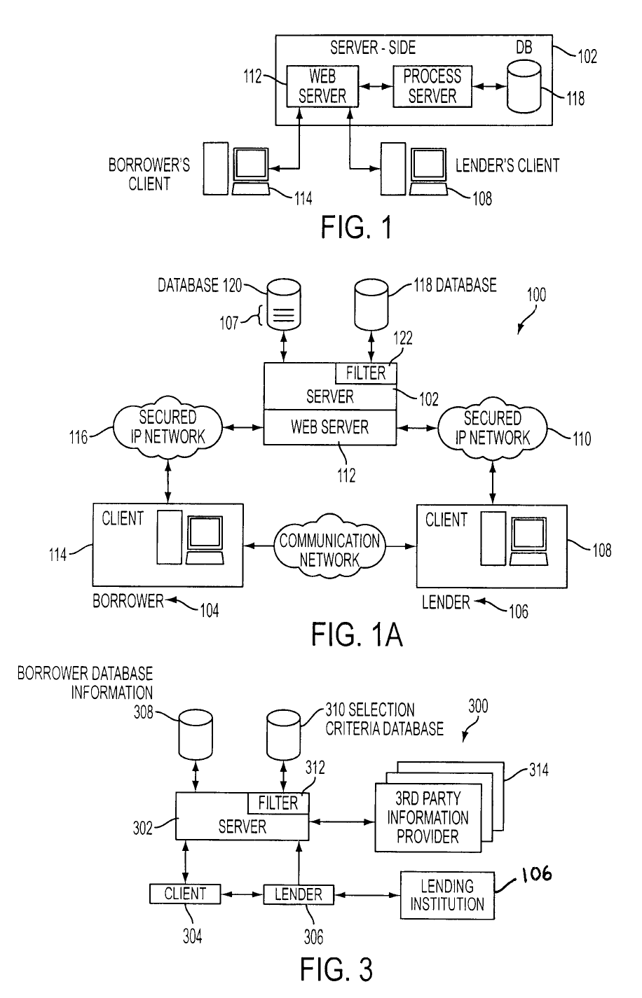

FIG. 1 and FIG. 1A are drawings depicting a schematic of the system architecture of a loan coordinating system 100 according to one aspect of the present invention. For purposes of illustrating the invention, the loan coordinating system 100 will be discussed in connection with a student loan referral program; however, it should be noted that the loan coordinating system 100 could also be employed in any money-borrowing program, such as automobile loans.

The loan coordinating system 100 includes a server subsystem 102, a borrower or user 104 of the loan coordination system 100, and a lending institution 106.

It is contemplated that the lending institution 106 will submit, transmit, or provide/make available selection criteria 107 to the server subsystem 102 using the lending institution client 108 in data communication over a first data communications network 110 with a web server 112 in the server subsystem 102. The selection criteria 107 may include, but is not limited to, loan type, school location, school name, graduate or undergraduate status, current year in school, selected or anticipated major, desired loan amount, date loan funds are needed, a general credit rating (i.e., good, fair, bad), co-borrower or co-signer information, and references information.

The selection criteria 107 may be saved in a system server database 118, which may be associated with the server subsystem 102. The selection criteria 107 may instead be stored in a database or memory device (not shown) associated with the lending institution client 108 at the lending institution 106, in which case the selection criteria 107 would need to be downloaded each time the lending institution client 108 is contacted by the server subsystem 102. The selection criteria 107 could also be distributed over several databases, including some selection criteria 107 being stored in the system server database 118 and some being stored in the database associated with the lending institution client 108.

The borrower/user 104 will submit general and/or personal information to the server subsystem 102 using a borrower client 114 in data communication over a second communications network 116 with the web server 112 in the server subsystem 102 in order to use or access the loan coordinating system 100. The supplied general and personal information may be saved in a database 120, which could be the same as or different than the system server database 118.

The general and personal information may include, but is not limited to, loan type, school location, school name, graduate or undergraduate status, current year in school, selected or anticipated major, expected graduation date, desired loan amount, date loan funds are needed, best time to contact the borrower, first name, last name, social security number (optional), a user-provided credit rating (i.e., good, fair, bad), date of birth, email address, residence address, mailing address information, drivers license state and number, co-borrower or co-signer information, and references information. Other information provided by the borrower/user 104, either to the server subsystem 102, or directly to one or more of the lending institutions 106, includes, but is not limited to, a summary of the borrower's assets, annual income passwords, and user-profile preferences.

Different techniques for inputting the general and personal information are contemplated as being part of the invention. The most common means used today includes an electronic form generated by a software application, such as a browser, residing on the borrower client 114 that requests the general and personal information. The form may be generated based on signal instructions received from the web server 112, and may include, but is not limited to, text entry fields, radio buttons, drop down boxes, and check boxes. For example, the borrower/user 104 may enter general and personal information about a self-assessment of his or her credit worthiness using a drop-down menu that asks whether the borrower/user 104 has “excellent,” “good,” or “poor,” credit, or which state the borrower/user 104 lives in.

The server subsystem 102 includes a filtering process 122 that will intake the selection criteria 107 stored in the system server database 118 to identify whether the general and personal information submitted by the borrower/user 104 meets the selection criteria 107 submitted by the lending institution 106. That is, for each individual selection criteria 107, the general and personal information will be reviewed to see if it satisfies the individual selection criteria 107. Based on the result of the filtering process 122, the web server 112 will generate instructions to be communicated back to the borrower client 114.

In one embodiment of the invention, the web server 112 may generate instructions to generate an email that is forwarded to one or more lending institution clients 108 thereby providing information to the lending institutions 106. Such information may include, among other things, an identification of, or general non-identifying information about, a borrower/user 104 whose general and personal information matches at least some of the lending institution's 106 individual or aggregate selection criteria 107. The email may be a standard text message, or it may contain various multimedia features, including images in addition to text, which may be generated by embedding HTML code in the email in such a way that the recipient's email text editor automatically launches a software application to view the email message.

In one aspect of the email notification, the email may include a hypertext link to the server subsystem 102 that, if activated, will allow the lending institution client 108 to communicate with the server subsystem 102 and download some of the general and personal information about the borrower/user 104 necessary for the lending institutions 106 to contact the borrower/user 104 to advance toward closing a student loan for the borrower/user 104.

In another aspect of the email notification, the email may instead include a hypertext link that, if activated, may cause an HTML page to be generated on one or more lending institution clients 108 thereby providing information to the lending institutions 106 that includes, among other things, an identification of, or general non-identifying information about, a borrower/user 104 whose general and personal information matches at least some of the lending institution's 106 individual or aggregate selection criteria 107. The generated page may include a hypertext link to the server subsystem 102 that, if activated, will allow the lending institution client 108 to communicate with the server subsystem 102 and download some of the general and personal information about the borrower/user 104 necessary for the lending institutions 106 to contact the borrower/user 104 to advance toward closing a student loan for the borrower/user 104.

Alternatively, rather than sending an email notification, the web server 112 may instead generate instructions to generate an HTML page on one or more lending institution clients 108 thereby providing information to the lending institutions 106 that includes, among other things, an identification of, or general non-identifying information about, a borrower/user 104 whose general and personal information matches at least some of the lending institution's 106 individual or aggregate selection criteria 107. The generated page may, as noted above, include a hypertext link to the server subsystem 102 that, if activated, will allow the lending institution client 108 to communicate with the server subsystem 102 and download some of the general and personal information about the borrower/user 104 necessary for the lending institutions 106 to contact the borrower/user 104 and advance toward closing a student loan for the borrower/user 104.

In another embodiment of the invention, the web server 112 may generate instructions to generate an HTML page describing a simple list of matching lending institutions with contact information.

In another embodiment of the invention, the web server 112 may generate instructions to generate a list of HTML (or other markup language) links to be communicated via the second data communications network 116 to the borrower client 114 for display to the borrower/user 104. The links may be used to convey some of the general or personal information about a borrower/user 104 to one or more lending institution clients 108. In this embodiment, the link may contain data variables representing certain portions of the general and personal information relevant to the lending institution that may be parsed by a lending institution web server 126. The borrower/user 104 may then click on a link to access the lending institution web server 126 via a third data communications network 124. Clicking on a link simultaneously sends a signal from the borrower client 114 to the server system 102 indicating that a successful referral has occurred. The borrower/user 104 may then interact directly with the lending institution web server 126.

The borrower/user 104 and the lending institution 106 may communicate with and receive information provided by the loan coordinating system 100 using wired or wireless electronic client devices, such as the lending institution client 108 and borrower client 114. The client devices 108, 114 could be, for example, a wireless telephone, a wired telephone, a personal data assistant, a portable computer, and/or a desktop computer. Combinations of those electronic devices, or other types of electronic devices capable of sending and receiving electronic, optical, and electro-optical signals, are contemplated as being within the nature and scope of the present invention.

As shown in FIG. 1, the lending institution client 108 is connected to a first data communications network 110, the borrower client 114 is connected to a second data communications network 116, and the lending institution client 108 and the borrower client 114 are connected to the third data communications network 124. The particular connectivity of the lending institution client 108 and the borrower client 114 to the first, second, and third data communications networks 110, 116, 124 is for illustrative purposes only.

The first, second, and third data communications networks 110, 116, 124 may be, for example, a wireless network used by mobile computing devices like cellular telephones, the Internet, an intranet, or some other data communication system. Preferably, the first, second, and third data communications networks 110, 116, 124 are packet-switched networks capable of routing hypertext, extensible, or other types of markup language code and data in accordance with the standard Internet Protocol or some other protocol in order to generate web pages. In particular, data may be exchanged over these networks by employing the Commonline Data standardized format and delivery process commonly used for the exchange of origination, disbursement and change transaction data between educational institutions and their federal and private student loan service providers. The Internet Engineering Task Force is the standards body that creates and maintains the basic standards on which the Internet depends, including the Internet Protocol specification published in 1981.

The first and second data communications networks 110, 116 are connected or interconnected to the server subsystem 102, which may include one or more server computers (not shown) that are adapted to, among other things, store and process data, protect data, and provide access to the server subsystem 102 using a firewall or some other security measure, generate responses to client device requests for markup language files and information, and provide access to user information.

The borrower/user 104 and the lending institutions 106 may use one or more of the electronic client devices such as the lending institution client 108 and the borrower client 114 to access the server subsystem 102, preferably via a web site graphical user interface that is generated on the electronic lending institution client 108 and the borrower client 114 using markup language commands and data provided to those devices by the server subsystem 102.

The server subsystem 102 is capable of interfacing with one or more of the system server database 118 and the database 120 as shown in FIG. 1. The system server database 118 could be, for example, a database containing records of each lending institution's 106 profile and selection criteria 107.

As described above, the many objects of the present invention may be used in connection with coordinating student loans between borrowers, interested in borrowing money and lending institutions interested in lending money to selected borrowers. However, the system may be used in other ways.

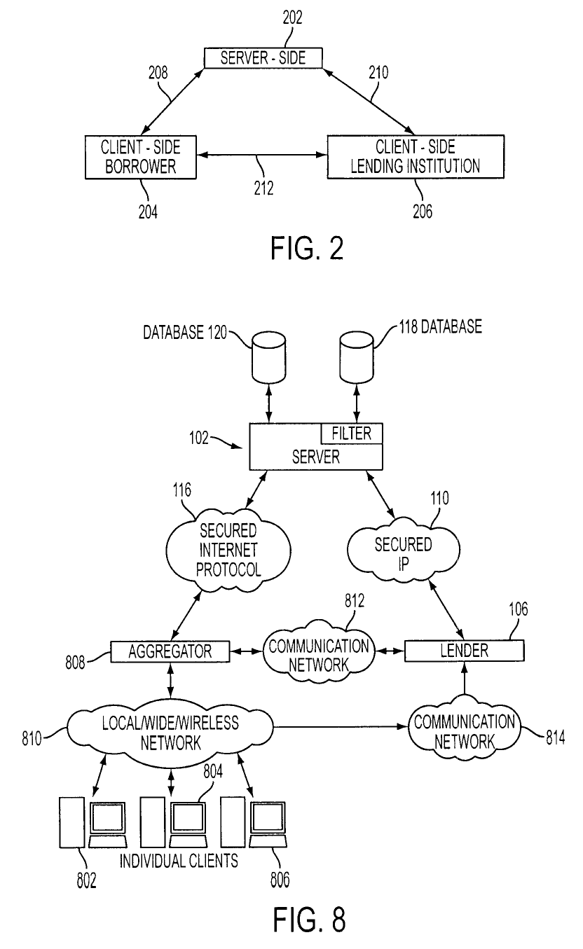

FIG. 2 shows the general client-server architecture of a loan coordinating system 200 according to another embodiment of the invention. As shown in FIG. 2, a server subsystem 202 is in data communication with a borrower client subsystem 204 and a lending institution client subsystem 206. Data communication between the server subsystem 202 and the borrower client subsystem 204 occurs over a first communications network 208. Data communication between the server subsystem 202 and the lending institution client subsystem 206 occurs over a second communications network 210. The borrower client subsystem 204 is in data communication with the lending institution client subsystem 206 over a third communications network 212. The first, second, and third communications networks 208, 210, 212 may be separate communications networks as illustrated, or the same network (not shown).

FIGS. 3-7 are drawings depicting schematics of the server-side architecture of the loan coordinating system according to one embodiment of the invention. For example, shown in FIG. 3 is a server subsystem 300 in which a server 302 is in data communications with a borrower client 304 and a lending institution client 306. The server 302 may be in data communication with one or more databases 308, 310 for storing personal information received from the borrower clients 304 and selection criteria 107 received from the lending institutions 106 by way of the lending institution clients 306. The server subsystem 300 includes a filtering process 312 for identifying lending institutions 106 that would be interested in loaning money to borrowers 104 based on the personal information submitted to the server subsystem 300 by the borrowers 104, and the selection criteria 107 submitted to the server subsystem 300 by the lending institutions 106. The server 302 may also be in data communication with one or more third party information providers 314 for retrieving information relevant to generating a list of lending institutions 313 which the borrowers 104 may contact or be contacted by. The third party information providers 314 may include, but are not limited to, credit reporting bureaus, financial institutions, government agencies, or providers of data such as current interest rates, currency values, or other indicators of market conditions.

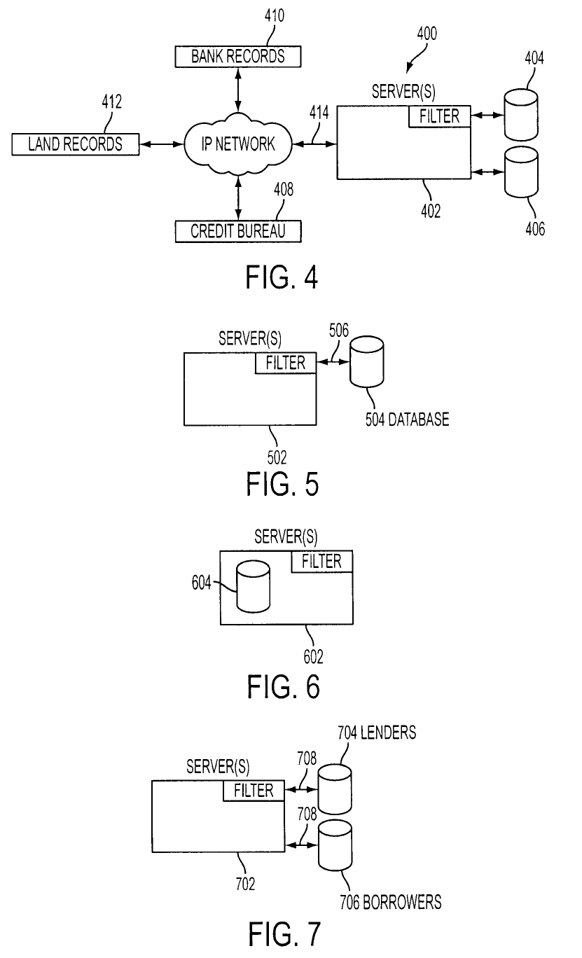

FIG. 4 is another drawing depicting a schematic of the server-side architecture of a server subsystem 400 according to another aspect of the present invention. In this case, one or more servers 402 are in data communications with one or more databases 404, 406. The servers 402 may also be in data communication with one or more third party information providers 408, 410, 412 for retrieving information relevant to generating a list of lending institutions which a borrower may contact. Third party information providers 408, 410, 412 may be, for example, credit reporting bureaus, financial institutions, government agencies, or providers of data such as current interest rates, currency values, or other indicators of market conditions. The servers 402 and the third party information providers 408, 410, 412 are connected to each other via a first data communications network 414. The particular connectivity of the servers 402 and the third party information providers 408, 410, 412 to the first data communications network 414 is for illustrative purposes only. The first data communications network 414 may be, for example, a wireless network used by mobile computing devices like cellular telephones, the Internet, an intranet, or some other network system.

FIGS. 5-7 are additional drawings depicting schematics of the server-side architecture of a server subsystem, these representing different server-database architectures than those previously discussed. For example, FIG. 5 includes a server 502 in data communication with a database 504 external to the server 502 via a communications network 506. The database 504 may be used to store lending institution selection criteria 107 and/or borrower personal information. The database 504 may be a single database repository that is centrally located proximate to the server 502, or it may consist of multiple databases distributed at various geographic locations. One of ordinary skill in the art will appreciate that there are many ways to construct and operate a database structure and manage database records that are not all located at a central database.

FIG. 6, which is a drawing of a schematic showing a server 602 in data communication with a database 604 internal to the server 602. The database 604 may store lending institution selection criteria 107 and/or borrower personal information.

In another embodiment, as shown in FIG. 7, a server 702 is in data communication with one or more databases 704, 706 external to the server 702 via a communications network 708. The databases 704, 706 may each store lending institution selection criteria 107 and/or borrower personal information.

Further to the embodiment depicted in FIG. 1, FIG. 8 is a schematic drawing depicting of the system architecture of a loan coordinating loan coordinating system 100 according to another aspect of the present invention. In the embodiment shown, individual borrower clients 802, 804, 806 (representing different users, who are not shown) are in data communication with an aggregator 808 via a communications network 810.

The aggregator 808 may be, for example, a student loan office of a university that handles processing of student loan requests by providing prospective and current students with an on-line personal account in which they may enter personal information and submit it to the university for transmission to the server subsystem 102. The aggregator 808 may instead be, for example, a third party provider that collects and manages information from multiple prospective borrowers for a fee, such as a lending institution that aggregates information associated with all borrowers in a geographical location, or information associated with borrowers requesting a similar amount of borrowed money, or that satisfy some other specific criteria.

The aggregator 808 combines the personal information of the individual borrower clients 802, 804, 806 and sends the information to the server subsystem 102 via the second data communications network 116. The server subsystem 102 processes the personal information as described above, and returns to the aggregator 808, for example, contact information for matching lenders or HTML links to the web sites of identified lending institutions 106, or emails to the lending institution clients 108, as previously described. The aggregator 808 may then wait to be contacted by any or all of the matching lending institutions 106. Alternatively, the aggregator 808 may interface via a communications network 812 with the one or more identified lending institutions 106 directly in the manner described previously in order to obtain favorable loan terms for the individual borrower clients 802, 804, 806, or it may forward or pass on the HTML links, emails, or other information to the individual borrower clients 802, 804, 806 which may then interface with the lending institutions 106 via a communications network 814.

When either the aggregator 808 or the individual borrower clients 802, 804, 806 click on an HTML link on a webpage, in an email, or otherwise respond to the server subsystem 102, a signal is sent via the second data communications network 116 to the server subsystem 102 to indicate a successful referral as previously described. The communications networks 116, 110, 810, 812, 814 may be separate communications network (as illustrated) or different networks (not shown).

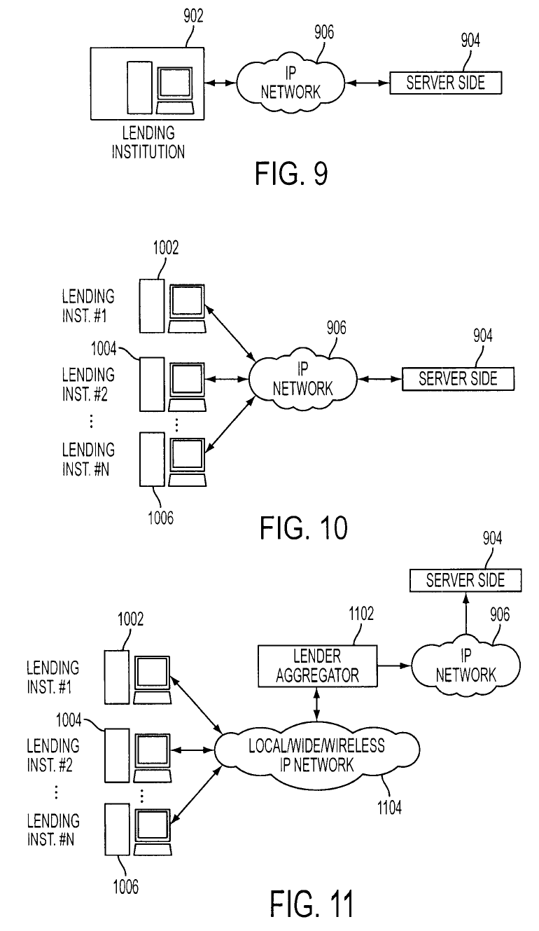

FIGS. 9-11 are schematic drawings of the lending institution client-side architecture of a loan coordinating system according to still other embodiments of the present invention. For example, FIG. 9 depicts a lending institution subsystem 902 in data communication with a server subsystem 904 via a communications network 906.

FIG. 10 illustrates a plurality of lending institution subsystems 1002, 1004, 1006 in data communication with the server subsystem 904 via the communications network 906.

FIG. 11 illustrates the plurality of lending institution subsystems 1002, 1004, 1006 being in data communication with a lending institution aggregator 1102 via a communications network 1104. The lending institution aggregator 1102 is in data communication with the server subsystem 904 via the communications network 906. The particular connectivity of the subsystems 902, 1002, 1004, 1006, the lending institution aggregator 1102, and the server subsystem 904 to the networks 906, 1104 is for illustrative purposes only. The lending institution aggregator 1102 may be, for example, a financial institution or a plurality of subsidiary financial institutions that, by aggregating selection criteria 107 of the subsidiary financial institutions, allows the financial institution to more efficiently make loans across the subsidiary financial institutions. The communications networks 906, 1104 may be, for example, a wireless network used by mobile computing devices like cellular telephones, the Internet, an intranet, or some other network system.

FIGS. 12-15 are schematic drawings of the borrower client-side architecture of a loan coordinating system according to still other embodiments of the present invention, these embodiments representing different borrower subsystem architectures. Borrowers, as indicated previously, may be consumers looking for student loans, automobile loans, home loans, or other financial debt instruments.

FIG. 12 is a schematic drawing of a basic borrower subsystem 1202 in data communication with the server subsystem 904 via a communications network 1204.

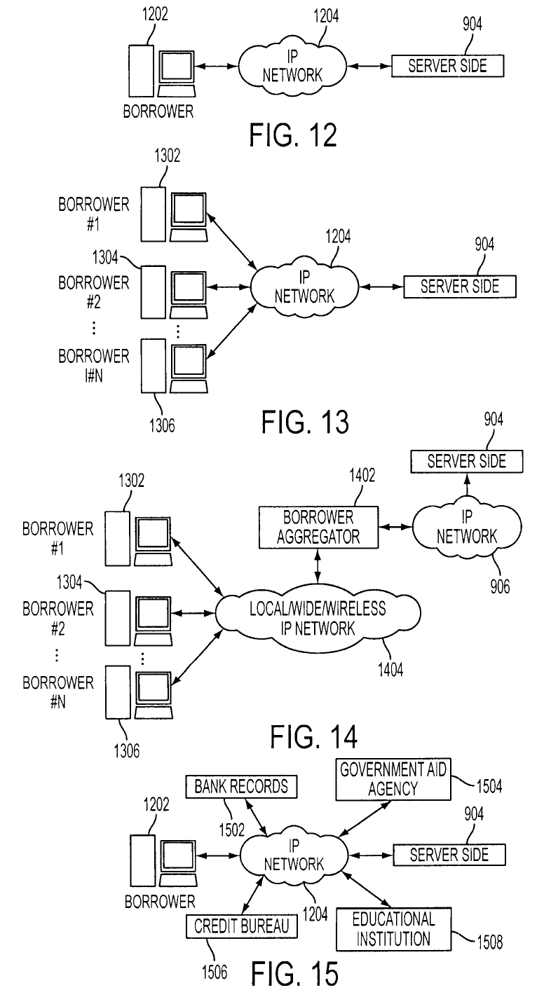

FIG. 13 is a schematic drawing of a plurality of borrower subsystems 1302, 1304, 1306 in data communication with the server subsystem 904 via a communications network 1204.

FIG. 14 illustrates the plurality of borrower subsystems 1302, 1304, 1306 in data communication with a borrower aggregator 1402 via a communications network 1404. The borrower aggregator 1402 is in data communication with the server subsystem 904 via the communications network 906. The borrower aggregator 1402 may be, for example, a university financial aid department representing a plurality of students seeking student loans, as described above. By aggregating the general and personal information of a plurality of students, the university may more efficiently coordinate student loans for the plurality of students. The particular connectivity of the borrower subsystems 1302, 1304, 1306, the borrower aggregator 1402, and the server subsystem 904 to the communications networks 906, 1404 is for illustrative purposes only. The communications networks 906, 1404 may be, for example, a wireless network used by mobile computing devices like cellular telephones, the Internet, an intranet, or some other network system.

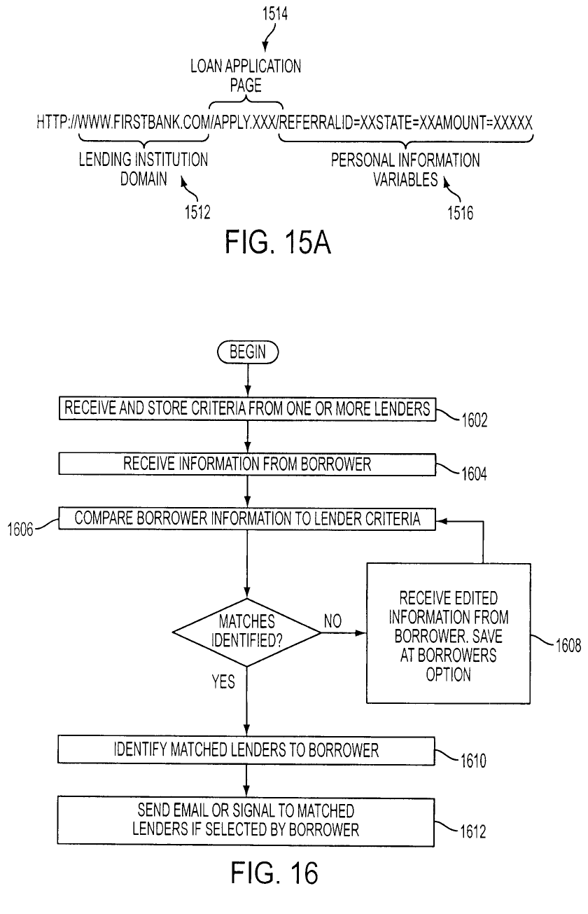

FIG. 15 is another schematic drawing of a borrower client-side architecture of a borrower subsystem according to another aspect of the present invention. In this case, a borrower subsystem 1202 is in data communications with one or more third party information providers 1502, 1504, 1506, 1508 for retrieving information relevant to submitting general and personal information requested by the server subsystem 904. The third party information providers 1502, 1504, 1506, 1508 may be, for example, credit reporting bureaus, financial institutions, government agencies, or educational institutions. The borrower subsystem 1202 and the third party information providers 1502, 1504, 1506, 1508 are connected to a first data communications network 1204. The particular connectivity of the borrower subsystem 1202 and the third party information providers 1502, 1504, 1506, 1508 to the first communications network 1204 is for illustrative purposes only. The communications network 1204 may be, for example, a wireless network used by mobile computing devices like cellular telephones, the Internet, an intranet, or some other network system.

FIG. 15A is a drawing representing an HTML link 1510 containing borrower personal information as described above. The link contains the domain name 1512 of an identified lending institution 106 website to which the borrower/user 104 will be directed if the HTML link 1510 is activated. The HTML link 1510 also contains a filename 1514 of a particular webpage on the lending institution's 106 website to which the borrower would be directed. The borrower's 104 general and personal information, or a portion thereof, may be stored as a series of variables 1516 that may be parsed by the lending institution client 108 or lending institution web server 126. Thus, when the borrower/user 104 clicks on the HTML link 1510, certain general and personal information is then transmitted from the borrower client 114 to the lending institutions 106 and may be used to, for example, pre-populate certain loan application forms or otherwise be used in connection with closing a loan with the borrower/user 104.

II. System Operation.

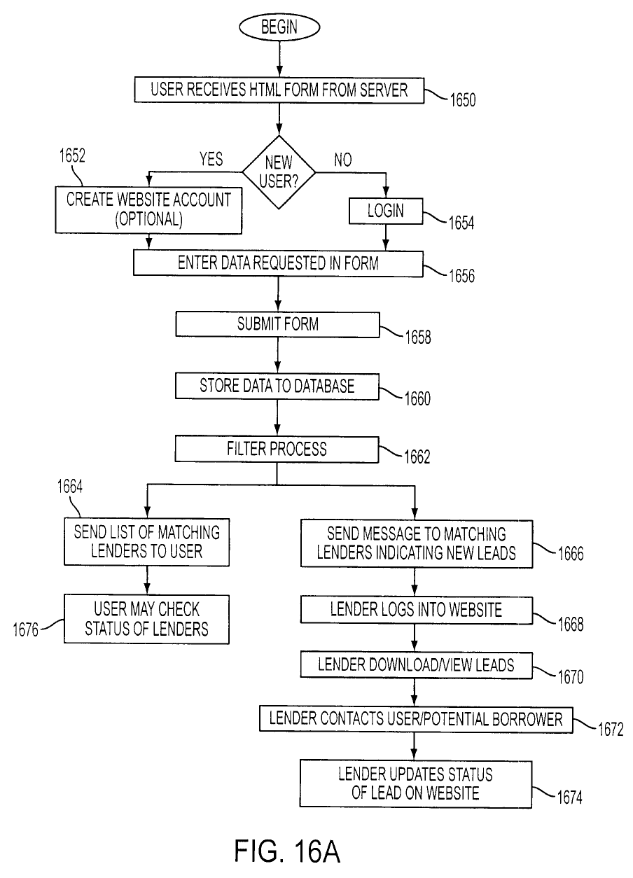

FIG. 16 is a process flow diagram depicting the server-side process flow steps according to one embodiment of the present invention. In process step 1602, the server subsystem 102 receives at the web server 112 via the first data communications network 110 the selection criteria 107 from one or more lending institutions 106, and stores the selection criteria 107 in the system server database 118.

In process step 1604, the server subsystem 102 receives from a borrower/user 104 interested in borrowing money, general and personal information about the borrower or another person. The general and personal information may be stored in the database 120. The general and personal information is checked for completeness and to ensure that it satisfies certain quality standards (e.g., punctuation, missing characters, special formats for items like phone numbers and email addresses, etc.).

In process step 1606, the server subsystem 102 applies a filtering process 122 to determine whether the selection criteria 107 are satisfied by the borrower's 104 general and personal information. This is expected to be an iterative process, such that if there are five selection criteria 107, each of the five individual selection criteria 107 are compared, sequentially or in parallel, to the general and personal information stored in the system server database 118, in order to assess whether there is a match.

It is contemplated that some of the selection criteria 107 may be applied during the filtering process 122 in such a manner that even if the general and personal information does not specifically match the selection criteria 107, the server system 102 will still count the comparison as a match and count the borrower/user 104 as a potential referral. One way to accomplish this is, for each selection criteria 107 that has a numerical format, to assign a specific numerical percentage factor (e.g., ±1%, ±10%) or variable (e.g., “yes,” “no”) that defines an acceptable deviation from the individual selection criteria 107 provided by the lending institutions 106. The specific percentage factor or variable may be adjusted for each lending institution 106. For example, if an individual selection criteria 107 is “loan amount <50,000” and the general and personal information provided by a borrower/user 104 includes a desired loan amount of $51,000, the server subsystem 102 may, if all other selection criteria 107 are satisfied, identify the borrower/user 104 as a potential match and refer the lead to the lending institution 106 if the applied numerical factor applied to the 50,000 selection criteria is ±2%.

If no matching lending institutions 106 are found after applying the filtering process 122, the server subsystem 102 informs the borrower/user 104 that there are no identified lending institutions 106, and the borrower/user 104 is given the opportunity to change the general and personal information entered, and resubmit the information as depicted in process step 1608. The borrower/user 104 may choose to edit his or her general and personal information to reflect, for example, a smaller amount of money desired or the existence of a guarantor. The edited information is again checked for completeness and quality before being subjected to the filtering process 122.

If the filtering process 122 identifies one or more matching lending institutions 106, as depicted in process step 1610, the server subsystem 102 will output to the borrower/user 104 a list of all or a fraction of the matching lending institutions 106. The list may be in the form of HTML links to the web sites of the one or more matching lending institutions 106, or it may be an HTML table allowing the borrower/user 104 to select one or more of the matching lending institutions 106 by clicking on a form, or by some other means of presenting the list to the borrower/user 104 for subsequent selection. The number of links or selections may be equal to or less than the total number of identified matching lending institutions 106, or at least one if there is only one match. The presentation of the matched lending institutions 106 is determined at random or according to pre-determined criteria (e.g., pay-per-rank, size of lending institution, historical level of lending, etc.). It is contemplated that a borrower/user 104 will select three to six matching lending institutions 106 on average, but that number may be higher or lower.

In addition to allowing the borrower to contact any of the matching lending institutions 106, the list will provide the borrower/user 104 with the option to contact all the matched lending institutions 106 that are displayed.

In process step 1612, the server subsystem receives from the borrower client 114 a signal indicating that the borrower/user 104 has clicked on one or more of the HTML links or otherwise selected one or more of the matching lending institutions 106 presented to the borrower/user 104.

FIG. 16A is another process flow diagram depicting the client and server-side process flow steps according to another embodiment of the present invention. In process step 1650, a borrower/user 104 interfaces with the loan coordinating system 100 by visiting a website through a networked computer 114 via the server subsystem web server 112 or by some other means as described above. The networked computer 114 interfaces with the server subsystem web server 112 via the second data communications network 116 and receives HTML pages (or other markup language pages).

As described in process step 1652, if the borrower/user 104 is new to the site, he or she is prompted to create a new website account and/or complete an online form that allows the borrower/user 104 to use the loan coordination system 100 without an account. If the borrower/user 104 is a returning borrower/user 104 of the loan coordination system 100, he or she is prompted to log in as described in process step 1654. The web server 112 generates instructions to provide tools and advice to the borrowers/users 104, a dynamic college directory, a financial gap analysis, a contact form, a support form, company information, a demonstration of some of the features of the loan coordination system 100, and access to various templates for entering general and personal information, each template tailored to a specific type of loan being requested.

In process step 1656, the borrower/user 104 supplies at least some of the general and personal information requested by the server subsystem 102 as displayed in a form on the borrower client 114.

In process step 1658, the borrower/user 104 submits the general and personal information to the server subsystem web server 112.

In process step 1660, all or some of the borrower/user's 104 general and personal information is stored to the system server database 118.

In process step 1662, the filtering process 122 of the server subsystem 102 loads all or some of the lending institution's 106 selection criteria 107 from storage or downloads all or some of the selection criteria 107 from the lending institution clients 108, and then compares all or some of the selection criteria 107 to the provided general and personal information from the borrower/user 104 to identify matching lending institutions 106.

In process step 1664, the server subsystem 102 may send a list of matching lending institutions 106 to the borrower/user 104, optionally including the contact information or link to each of the matching lending institutions, 106.

As shown in process step 1666, the server subsystem 102 may send a notification to the matching lending institutions 106 that new leads have been generated by the loan coordinating system 100 based on the selection criteria 107 provided by the lending institution 106. The notification may contain one or more links that when activated cause the loan coordinating system 100 login screen to be displayed at the lending institution client 108, 306.

In process step 1668, the lending institution 106 logs in to the server subsystem 102 as directed by the notification. The lender may view or download new leads identified by the loan coordinating system 100 as described in process step 1670, by downloading some or all of the stored general and personal information. The lending institution 106 may then contact the borrower/user 104 that has been identified as meeting the lender's selection criteria 107 directly by phone or other methods as described in process step 1672. In this manner, the lending institution 106 is responsible for all loan decisions concerning the borrower/user 104.

In process step 1674, the lending institution 106 may log into the server subsystem 102 to update the status of the loan process with respect to the identified borrower/user 104.

In process step 1676, the borrower/user 104 may log into the website to determine the status of the loan process with respect to each of the matching lending institutions 106 that he or she selected.

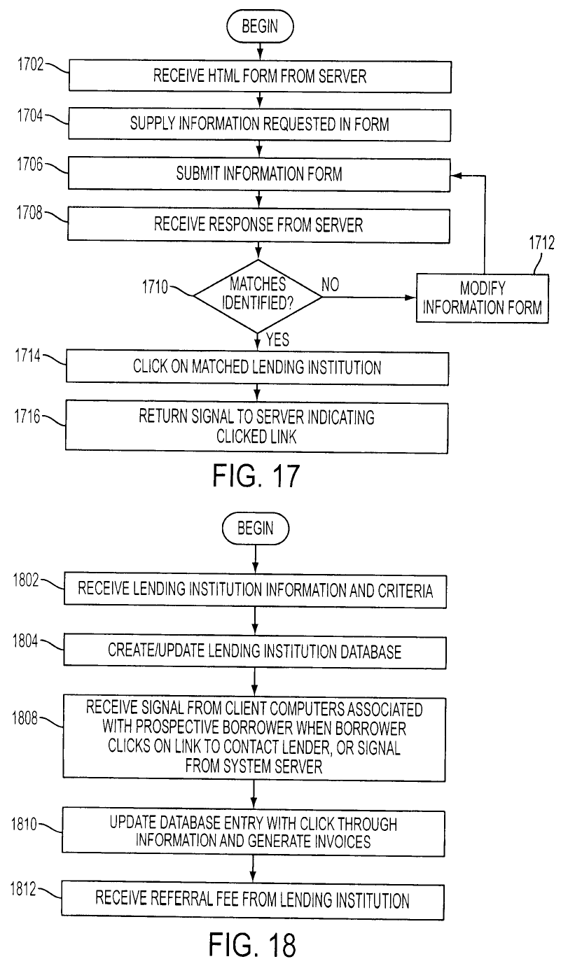

FIG. 17 is a process flow diagram according to another embodiment of the present invention. In process step 1702, a borrower/user 104 interfaces with the loan coordinating system 100 by visiting a website through a borrower client 114 via the server subsystem web server 112 or by some other means as described above. The borrower client 114 interfaces with the server subsystem web server 112 via the second data communications network 116 and receives a website form or link or some other means for inputting requested general and personal information.

In process step 1704, the borrower/user 104 supplies at least some of the requested general and personal information from the borrower client 114. Supplying the general and personal information may include creating a website account if the borrower/user 104 is a new borrower/user 104 of the loan coordination system 100.

In process step 1706, the borrower/user 104 submits the general and personal information to the server subsystem web server 112.

In process step 1708, the borrower/user 104 receives a response from the server subsystem web server 112.

In process step 1710, if the borrower/user 104 does not receive from the server subsystem 102 an identified matching lending institution 106, the borrower/user 104 may modify the previously-provided general and personal information and resubmit it or provide the information to the server subsystem 102 as depicted in process step 1712, or the borrower/user 104 may exit the loan coordinating system 100.

If the borrower/user 104 receives from the server subsystem 102 a list of one or more matching lending institutions 106, the borrower/user 104 may select, for example by clicking on one or more HTML links, one or more of the matching lending institutions 106 as depicted in process step 1714.

In process step 1716, the borrower client 114 sends a signal to the server subsystem 102 indicating that the borrower/user 104 has selected one or more of the matching lending institutions 106. This signal is recorded by the server subsystem 102 to manage the number of referrals being created using the loan coordinating system 100, and is also a check to see if the borrower/user 104 has acted on any of the information provided about the matching lending institutions 106.

FIG. 18 provides a process flow diagram depicting the server-side referral tracking process flow according to a preferred embodiment of the present invention. In process step 1802, the web server 112 in the server subsystem 102 receives from a lending institution 106 information about the lending institution and the lending institution's selection criteria 107.

In process step 1804, the server subsystem 102 determines whether an entry for the lending institution 106 exists in the system server database 118. If an entry exists, the entry is updated with the information received from the lending institution 106. If no entry exists, a new entry is created in the system server database 118 using the received lending institution information and selection criteria 107. An entry in the database may include, but is not limited to, the name of the institution, the selection criteria 107, a record of successful referrals, and the referral fee paid by the lending institution to the referring agent.

In process step 1806, the server subsystem 102 transmits to a borrower/user 104 a file containing instructions to create a link, such as an HTML hyperlink, that points the borrower/user 102 to the lending institution web site 108 when the borrower/user's submitted personal information matches the selection criteria 107 of a lending institution.

In process step 1808, the server subsystem 102 receives from the borrower/user networked computer 114 a signal indicating that the borrower/user clicked on the HTML link. The signal includes an indication of the lending institution web site HTML link on which the borrower/user clicked.

In process step 1810, the server subsystem 102 updates the entry in the system server database 118 for the particular lending institution 106 to which the borrower/user 104 was referred, to reflect a successful fee-generating referral.

In process step 1812, a referral fee is received from the lending institution 106 for any referrals of borrower/users 104 made by the loan coordinating system 100 based on the lending institution's 106 selection criteria 107. The server subsystem 102 may then generate an invoice detailing the referrals made as recorded in the system server database 118 entry for a particular lending institution 106. The step of generating an invoice and sending the invoice to the lending institution 106 may be automated and may be performed intermittently or at predetermined time intervals.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A method for referring money borrowers to lending institutions, comprising, at a first server, the steps of:
receiving over a first communications network a set of selection criteria from at least one lending institution;
receiving over a second communications network a set of information from a first user, the set of information comprising information about a borrower;
comparing the set of selection criteria to the set of information;
identifying one of the at least one lending institutions whose set of selection criteria is satisfied by the set of information;
outputting to the user a first signal comprising information about the identified lending institutions; and
outputting to at least one of the identified lending institutions a second signal comprising instructions to access the first server and receive at least some of the information about the borrower.

2. The method according to claim 1, further comprising receiving a third signal from the at least one of the identified lending institutions about the status of a loan.

3. The method according to claim 1, further comprising the step of storing the set of selection criteria in a first storage medium.

4. The method according to claim 1, further comprising the step of storing the set information in a first storage medium.

5. The method according to claim 1, further comprising the step of outputting an invoice to the at least one of the identified lending institutions.

6. The method according to claim 1, wherein the second signal is outputted after receiving a selection signal from the user.

7. The method according to claim 1, where the first and second communications networks are the same network.

8. The method according to claim 1, wherein the user and the borrower are the same person.

9. The method according to claim 1, further comprising providing at the first server a set of adjustments to be made to at least one selection criteria in the set of selection criteria.

10. The method according to claim 1, wherein the set of information includes information about the first borrower selected from the group consisting of name, address, age, name of school, address of school, amount of loan, social security number, and date of birth.

11. A method operable at a first server for generating referrals in a money lending environment via a computer network comprising:
sending executable code to at least one lending institution computer for displaying and operating one or more forms for entering at least one selection criteria for generating at least one set of selection criteria;
receiving from the one or more lending institution computers the at least one set of selection criteria;
storing on a first storage medium associated with the first server the at least one set of selection criteria;
sending executable code to at least one borrower computer for displaying and operating one or more personal information forms for entering information for generating at least one set of information;
receiving from the one or more borrower computers the at least one set of information;
comparing the at least one set of information to the at least one set of selection criteria stored on the first storage medium to identify at least one matching lending institution;
generating computer executable code for displaying and operating one or more referral forms listing one or more links to some of the information;
sending the computer executable code for displaying and operating the one or more referral forms to the one or more lending institutions; and
receiving a signal indicating that the one or more lending institutions received at least some of the information.

12. The method according to claim 11, further comprising generating an invoice based on the signal indicating a referral.

13. The method according to claim 11, wherein the one or more referral forms comprise one or more HTML links to an Internet web site.

14. The method according to claim 13, wherein the one or more referral forms comprise an email.

15. A system for coordinating student loans comprising:
a server in data communication with one or more lending institution client computers, for entering and sending a plurality of selection criteria to the server, and one or more borrower client computers associated with borrowers interested in borrowing money, for entering and sending a set of information about the borrowers to the server;
a data processing subsystem for comparing the set of information to the plurality of selection criteria and returning a list of one or more matching lending institutions to the borrower and the lending institution client computers, wherein the list comprises at least one link; and
a signal receiving subsystem for receiving a signal from the lending institution client computers indicating an activation of the at least one link.

16. The system of claim 15, the server comprising a web server for serving Internet web pages.

17. The system of claim 15, wherein the at least one link is a hypertext link pointing to at least some of the personal information.

18. The system of claim 17, wherein each of the at least one link is associated with an account associated with the lending institution client computers.

19. The system of claim 18, further comprising means for computing the number of links activated.

20. The system of claim 15, further comprising a lending institution database accessible by the server containing a plurality of selection criteria for the one or more lending institutions.

21. The system of claim 15, further comprising a borrower database accessible by the server containing a plurality of sets of personal information for the one or more borrowers interested in borrowing money.

22. A system for coordinating student loans comprising, on a first server:
a storage medium in data communication with one or more client computers, the storage medium containing computer code operable to:
receive over a communications network a first set of selection criteria from one or more lending institutions;
receive over the communications network a first set of personal information from one or more borrowers interested in borrowing money;
compare the first set of personal information to the first set of selection criteria to identify at least one lending institution interested in lending money to the one or more borrowers interested in borrowing money;
output over the communications network information containing instructions to generate a listing of the identified one or more lending institutions on one or more borrower client computers and on the identified lending institution servers; and
receive over the communications network a signal from one or more identified lending institution client computers indicating that the at least one identified lending institution has contacted the one or more borrowers.

23. The system of claim 22, further comprising a database for storing the first and second sets of information.
